(19) United States
(12) Patent Application Publication
(10) Pub. No.: US 2018/0127254 A1
(43) Pub. Date: May 10, 2018

(54) DRINK PRODUCING APPARATUS WITH CLOSED CARBON DIOXIDE LINE CIRCUIT, HOUSEHOLD REFRIGERATION APPARATUS AND METHOD FOR OPERATING A DRINK PRODUCING APPARATUS

(71) Applicant: BSH HAUSGERAETE GMBH, MUENCHEN (DE)

(72) Inventors: KUDRET BAYSAL, GIENGEN BRENZ (DE); DELIA HAHN, HEIDENHEIM AN DER BRENZ (DE); MARCEL KIRSCHEN, GERSTHOFEN (DE); ANDREAS KLEINER, DORNSTADT (DE); CHRISTIAN MAYERSHOFER, GUNDREMMINGEN (DE); BERND METTEL, HERBRECHTINGEN (DE); CARSTEN WEISS, GIENGEN (DE)

(21) Appl. No.: 15/346,762

(22) Filed: Nov. 9, 2016

(51) Int. Cl. B67D 1/00; B67D 1/08; F25D 23/12

(52) U.S. Cl. CPC B67D 1/007; B67D 1/0071; B67D 1/0066; B67D 1/0884; F25D 23/12; B67D 1/0861; B67D 1/0078; B67D 1/0894; B67D 1/0016

(57) ABSTRACT

A drink producing apparatus includes:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second liquid state different from the first liquid state,
a decompression chamber for pressure reduction of the liquid in the conditioning container, wherein the decompression chamber is connected to the conditioning container by a line part of the line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device is a closed line circuit.

The invention also relates to a household refrigeration apparatus and to a method.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus. The invention also relates to a method for operating a drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which comprises a drink apparatus, which is formed for dispensing a drink at this household refrigeration apparatus itself.

Moreover, cold drink machines are also known, in which alcohol containing mixed drinks, for example cocktails, can be dispensed.

In known drink producing apparatuses for dispensing cooled drinks, mixing of the liquid jet with other additions upon dispensing is restricted.

Especially carbonized and thus liquids mixed with carbon dioxide lose carbon dioxide in filling into the vessel, whereby the quality of the drink is decreased.

Moreover, hygienic requirements are also to be accommodated. In known implementations, the liquid can heat in the lines of a line device and germ growth can occur.

### PRESENTATION OF THE INVENTION

It is the object of the present invention to provide a drink producing apparatus as well as a household refrigeration apparatus and a method, in which a line device in the apparatus is improved. It is also the object of the invention to more multi-functionally configure the line device and to more efficiently configure line paths as well as to improve the cooperation of line paths of the line device. It is also the object to particularly hygienically perform the leading of liquid in the drink producing apparatus and to improve the cleaning of the components. It is also the object to reduce the exit of carbon dioxide from the drink producing apparatus, which is added in the production of carbonized liquids for drinks to be dispensed, and to more multi-functionally configure the employment of carbon dioxide.

This object is solved by a drink producing apparatus, a household refrigeration apparatus and a method according to the independent claims.

A first aspect of the invention relates to a drink producing apparatus. It comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a conditioning container, in which the liquid can be conditioned in a second liquid state different from the first liquid state. The drink producing apparatus comprises a decompression chamber, which is formed for pressure reduction of the carbonized liquid in the conditioning container. The decompression chamber is connected to the conditioning container by a line part of a line device of the drink producing apparatus. The drink producing apparatus comprises a carbon dioxide addition unit for adding carbon dioxide to the liquid. The drink producing apparatus comprises a carbon dioxide line device, which is connected to the carbon dioxide addition unit for leading carbon dioxide from the carbon dioxide addition unit. The carbon dioxide line device is a closed line circuit. By such a configuration and the carbon dioxide retained in the drink producing apparatus, the portion of carbon dioxide, which is discharged from the drink producing apparatus into the environment, it at least considerably reduced, in particular avoided. By more multi-functional utilization of the carbon dioxide in the drink producing apparatus, the hygiene is also improved, since by supplying carbon dioxide into specific components of the drink producing apparatus, the microbial growth and thus germ formation is at least considerably reduced in these components too. Here, a fresh air supply in the liquid system of the drink producing apparatus is avoided. Thus, especially if in specific containers of the drink producing apparatus the liquid respectively stored therein decreases, introduction of carbon dioxide is performed to thus reduce the germ formation.

In a further advantageous aspect of the invention, the carbon dioxide line device comprises a line connection, which is connected to the decompression chamber and the dispensing container for leading carbon dioxide from the decompression chamber to the dispensing container. This is an advantageous implementation since upon reduction of the filling level of the liquid in the dispensing container, if it is for example led into the conditioning container or directly to the dispensing unit, it is thus refilled with carbon dioxide. This filling of the carbon dioxide is then effected not into the liquid, which is still contained in the dispensing container, but into the cavity of the dispensing container, which there arises by reducing the filling level. Thus, this cavity is then virtually filled with the carbon dioxide. By this implementation, in particular upon draining and thus removing liquid from the dispensing container, the occurrence of a local negative pressure is avoided by refilling carbon dioxide into it.

A further aspect of the invention provides that the carbon dioxide line device comprises a line connection, which is connected to the decompression chamber and the carbon dioxide addition unit for leading carbon dioxide from the carbon dioxide addition unit to the decompression chamber. By this configuration, the possibility of adding carbon dioxide to the decompression chamber is provided if carbonized liquid is dispensed to the dispensing unit of the drink producing apparatus from the decompression chamber. By the then in particular simultaneous supply of the carbon dioxide into the decompression chamber, the dispensing of the carbonized liquid is smoother and more uniformly allowed.

A further aspect of the invention provides that the carbon dioxide line device comprises a line connection, which is connected to the dispensing container and the carbon dioxide addition unit for leading carbon dioxide from the carbon dioxide addition unit to the dispensing container. By this configuration, it is then allowed performing refilling with carbon dioxide into the cavity then arising upon reducing the filling level of the liquid in the dispensing container. Thereby too, the microbial growth is then at least considerably reduced since fresh air supply to the dispensing container is not effected. In particular, the dispensing container is sealed in gas-tight manner after in particular completely filling with the liquid and only the carbon dioxide can be introduced via a correspondingly connected line connection at the dispensing container. In order to then avoid generation of a negative pressure in such a configuration if liquid is dispensed from the dispensing container, this carbon dioxide is then introduced into the dispensing container.

Preferably, the drink producing apparatus comprises a filling level capturing unit, by which a filling level of the liquid in the decompression chamber is captured. Thereby, the amount of carbonized liquid in the decompression chamber can be accurately determined. This has advantages to the effect that sufficient liquid can always be re-led from the dispensing container into the decompression chamber. An essential advantage is also to be regarded in that if a threshold filling level is reached or it is fallen below it, re-leading carbon dioxide into the decompression chamber is stopped. Especially if the threshold filling level is the completely emptied state of the decompression chamber, undesired re-leading of carbon dioxide into the decompression chamber and immediate discharge of this carbon dioxide to the dispensing unit then occurring is thereby then avoided such that undesired escape and dispensing of carbon dioxide via the dispensing unit is prevented.

It can be provided that the filling level capturing unit comprises at least one ultrasonic sensor. The filling level can be captured from above by an ultrasonic sensor by emitting the ultrasonic signal to the surface of the liquid, which is still contained in the decompression chamber. By corresponding reflection and a receiver then present, the filling level can be determined depending on the place of incidence of the reflected ultrasonic signal at the receiver.

The filling level capturing unit can also comprise at least one optical sensor. It can for example be formed as a horizontal light barrier. By this light barrier, the filling level can for example be captured through a transparent hose at an output of the decompression chamber or through a viewing window of the decompression chamber.

With an optical sensor, detection by reflection of a light beam in the decompression chamber can also be captured. For example, this can be effected if the bottom of the decompression chamber does not have liquid anymore and thus the light beam is then reflected on the bottom and can be correspondingly detected.

A further configuration of a filling level capturing unit can include at least one capacitive sensor.

It can also be provided that the filling level capturing unit comprises a gas sensor, which detects an increased concentration of a gas in the decompression chamber. If this gas concentration exceeds a threshold value, it can again be concluded that the filling level has reached the threshold filling level or has fallen below it.

In a further implementation, the filling level capturing unit can comprise a float switch.

Similarly, the filling level capturing unit can comprise two electrodes in a further configuration, which are formed for the liquid detection. For example, they can be arranged in different height positions and falling below the threshold filling level can be recognized if in particular both electrodes are no longer wetted by the liquid.

The filling level capturing unit can be arranged in the detection chamber itself. It can also be provided that the filling level capturing unit is arranged outside of the detection chamber and can capture the filling level through a wall of the detection chamber.

It can also be provided that another gas is introduced in addition to or instead of the use of carbon dioxide as a pressure equalization gas in the decompression chamber.

A further aspect of the invention relates to a household refrigeration apparatus with a housing, in which a receiving space for food is formed. The household refrigeration apparatus includes a drink producing apparatus. The drink producing apparatus comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a conditioning container, in which the liquid is conditioned in a second liquid state different from the first liquid state. The drink producing apparatus comprises a decompression chamber, which is formed for pressure reduction of the liquid in the conditioning container. The decompression chamber is connected to the conditioning container by a line part of a line device of the drink producing apparatus. The drink producing apparatus comprises a carbon dioxide addition unit. The drink producing apparatus also comprises a carbon dioxide line device, which is connected to the carbon dioxide addition unit for leading carbon dioxide from the carbon dioxide addition unit. The carbon dioxide line device is a closed line circuit. In particular, thus, none of the line parts of the carbon dioxide line device opens into the environment, but respectively opens into a further component of the drink producing apparatus.

A further aspect of the invention relates to a method for operating a drink producing apparatus. The drink producing apparatus is provided with a dispensing unit for dispensing liquid from the drink producing apparatus, a dispensing container and a conditioning container as well as a carbon dioxide addition unit. Furthermore, the drink producing apparatus is provided with a carbon dioxide line device, which is connected to the carbon dioxide addition unit for leading carbon dioxide from the carbon dioxide addition unit. Thus, a closed line circuit is provided in the carbon dioxide line device, in which the carbon dioxide is led. The liquid is added into the dispensing container with a first liquid state, which is in particular a non-carbonized state. In dispensing a drink with the liquid, the liquid is led from the dispensing container into the conditioning container and conditioning of the liquid in the conditioning container is performed. Therein, the liquid is brought into a second liquid state, which is a carbonized liquid state, different from the first liquid state. Thereto, carbon dioxide is led from the carbon dioxide addition unit into the conditioning container via the closed line circuit, wherein this carbon dioxide is directly introduced into the liquid in the conditioning container. Thereby, carbonic acid then arises in the liquid. Furthermore, the drink producing apparatus is provided with a decompression chamber, wherein this decompression chamber is connected to the conditioning container by a line part of a line device of the drink producing apparatus. If carbonized liquid is to be dispensed from the decompression chamber to the dispensing unit to then add this carbonized liquid to a drink to be dispensed, this liquid is led from the conditioning container into the decompression chamber. The pressure of the liquid, which it has in the dispensing container and with which the liquid arrives at the decompression chamber, is reduced in the decompression chamber. Thereto, carbon dioxide is discharged from the decompression chamber upon this pressure reduction. This discharged carbon dioxide is not discharged into the environment, but remains further contained in the closed line circuit. In particular, this carbon dioxide discharged from the decompression chamber is led to at least one further receiving component, in particular a container comprising liquid, of the drink producing apparatus in the closed line circuit, in particular led to the dispensing container. This pressure reduction of the liquid in the decompression chamber and the discharge of the amount of carbon dioxide, which then arises in the decompression chamber, can be performed before dispensing the drink from the dispensing unit.

In particular, before dispensing the drink from the dispensing unit, the liquid in the first liquid state is introduced into the dispensing container, wherein the dispensing container is preferably completely filled with this liquid thereto. After completely filling, the dispensing container is closed, in particular closed in gas-tight manner, such that infiltration of ambient air cannot occur via the filling opening of the dispensing container. The closure can for example be effected via a mechanical or via an electrical valve. If a drink is then subsequently to be dispensed and a corresponding dispensing desire is in particular performed by actuating an operating element by a user, thus, the liquid is discharged from the dispensing container and the liquid level or the filling level in the dispensing container decreases. This is effected both if this liquid is led from the dispensing container directly to the dispensing unit, but is also effected if this liquid is then led into the conditioning container to be carbonized there. Via a line connection preferably provided with a valve between the carbon dioxide addition unit and the dispensing container, carbon dioxide is then introduced into the dispensing container in an advantageous implementation, namely not directly into the liquid, but into the cavity arising by the decreasing filling level in the dispensing container. Thereby, negative pressure in the dispensing container is avoided. Moreover, the carbon dioxide inhibits the microbial growth in the dispensing container.

If dispensing of carbonized liquid is effected on the other hand, which is then first led from the dispensing container into the decompression chamber and led from there to the dispensing unit, the filling level of the carbonized liquid in the decompression chamber then also decreases. Upon reducing the liquid pressure in the decompression chamber, the carbon dioxide then arising either is not discharged into the environment, but discharged into the closed line circuit, where it is then preferably returned to the dispensing container from there. Thereby too, discharge of carbon dioxide into the environment is virtually avoided and undesirably high carbon dioxide concentrations in the area of the drink producing apparatus are avoided. Moreover, negative pressure in the dispensing container is also avoided or compensated for by this return into the dispensing container since the otherwise hermetically sealed dispensing container would cause undesired negative pressure in the dispensing container upon discharging the liquid.

For dispensing the carbonized liquid from the decompression chamber, fresh air is no longer supplied, for example via a pump, but it is replaced by supplying carbon dioxide from the closed line circuit.

If the dispensing container is empty, thus, it is then completely filled with carbon dioxide according to the above explained principle. It either then does not arrive at the environment. For refilling liquid into the dispensing container, a corresponding canister is preferably used. It can be coupled to the filling opening or fill-in opening of the dispensing container. If the preferably present valve at the filling opening of the dispensing container is opened thereto, thus, the liquid then flows from the canister into the dispensing container and the carbon dioxide in the dispensing container is urged into the canister on the other hand. If this canister is then emptied as far as the dispensing container is again completely filled with liquid, the valve at the filling opening of the dispensing container is again closed. Thereby, the infiltration of fresh air into the dispensing container can then be avoided by this procedure and the exit of carbon dioxide from the dispensing container into the environment can be avoided.

Preferably, it is provided that the drink producing apparatus comprises a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus comprises at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

Implementations of an independent aspect of the invention relating to the drink producing apparatus are to be regarded as advantageous implementations of the other independent aspects of the drink producing apparatus.

Furthermore, the invention also relates to a household refrigeration apparatus for storing and preserving food, which comprises a housing, in which a receiving space for food is formed. The household refrigeration apparatus moreover includes a drink producing apparatus according to the first independent aspect of the invention or according to the second independent aspect of the invention. The household refrigeration apparatus can be a refrigerator or a freezer or a combined refrigerator-freezer.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed comprises at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1; and

FIG. 3 a schematic representation of partial components of an embodiment of a drink producing apparatus according to the invention.

### PREFERRED EMBODIMENTS OF THE INVENTION

In the figures, identical or functionally identical elements are provided with the same reference characters.

In the figures, identical or functionally identical elements are provided with the same reference characters.

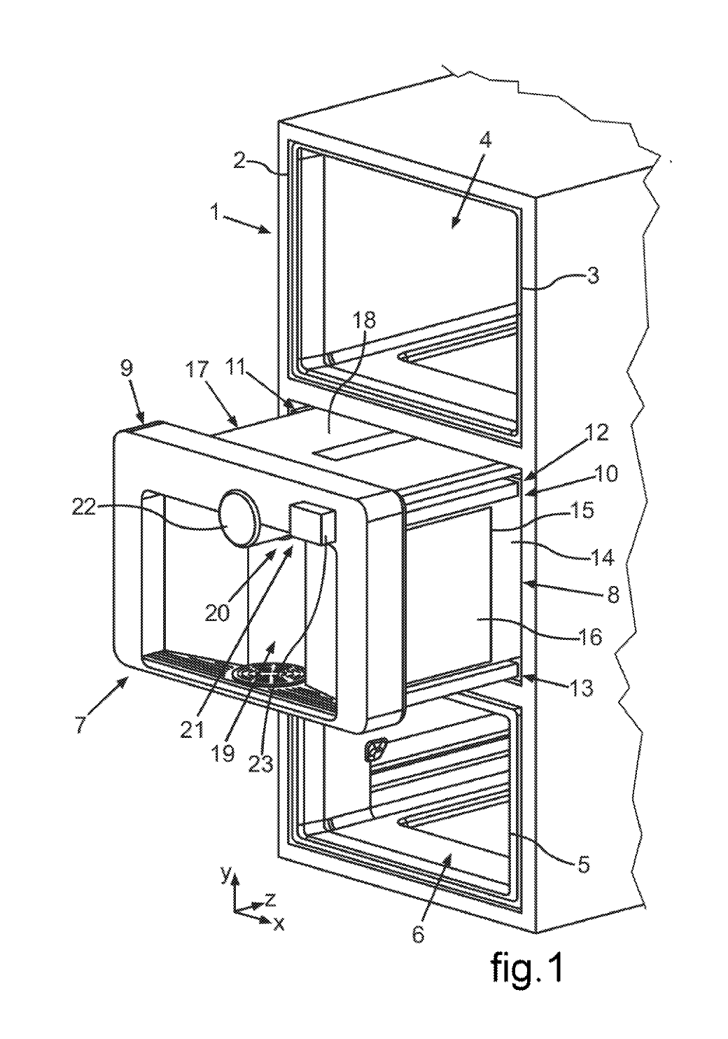

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 comprises a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which comprises multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also comprises an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 comprises a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule comprising the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 comprises a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 comprises a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 comprises a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

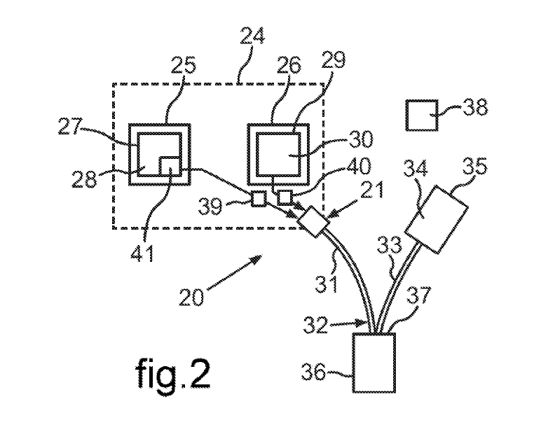

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 comprises a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or comprises water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 36 is placed in the placing bay 19 (FIG. 1).

The drink producing apparatus 7 also includes a control unit 38 for controlling the dispensing of the mixed drink.

In FIG. 2, it is preferably also provided that in the partial system, in which the liquid 28 is stored and led, a decompression chamber 39 is arranged. It is in particular arranged between the dispensing container 27 and the dispensing unit 20. The then in particular carbonized first liquid 28 is led into the decompression chamber 39 before leading out of the dispensing opening 21 and there reduced in its pressure. In particular, pressure reduction to about 2 bar is performed in the decompression chamber 39.

In an advantageous implementation, it is in particular provided that in addition or instead a further decompression chamber 40 is provided. It is arranged in the partial area or the system, in which the second liquid 30 is stored and led. It is correspondingly arranged between the further dispensing container 29 and the dispensing unit 20, in particular the dispensing opening 21. There too, pressure reduction can then be effected in the decompression chamber 40 if the second liquid 30 is provided in carbonized manner, in particular also again preferably to a pressure of about 2 bar.

In the schematic representation in FIG. 2, it is already apparent that in an embodiment, in which the drink producing apparatus 7 is formed as a mixed drink producing apparatus and thus provides two different liquids 28 and 30, which can be added to a drink to be dispensed, two separated systems are present, which provides storing and leading a liquid in the drink producing apparatus 7. These systems are preferably then respectively identically constructed and then each comprise the same or similar components in this context.

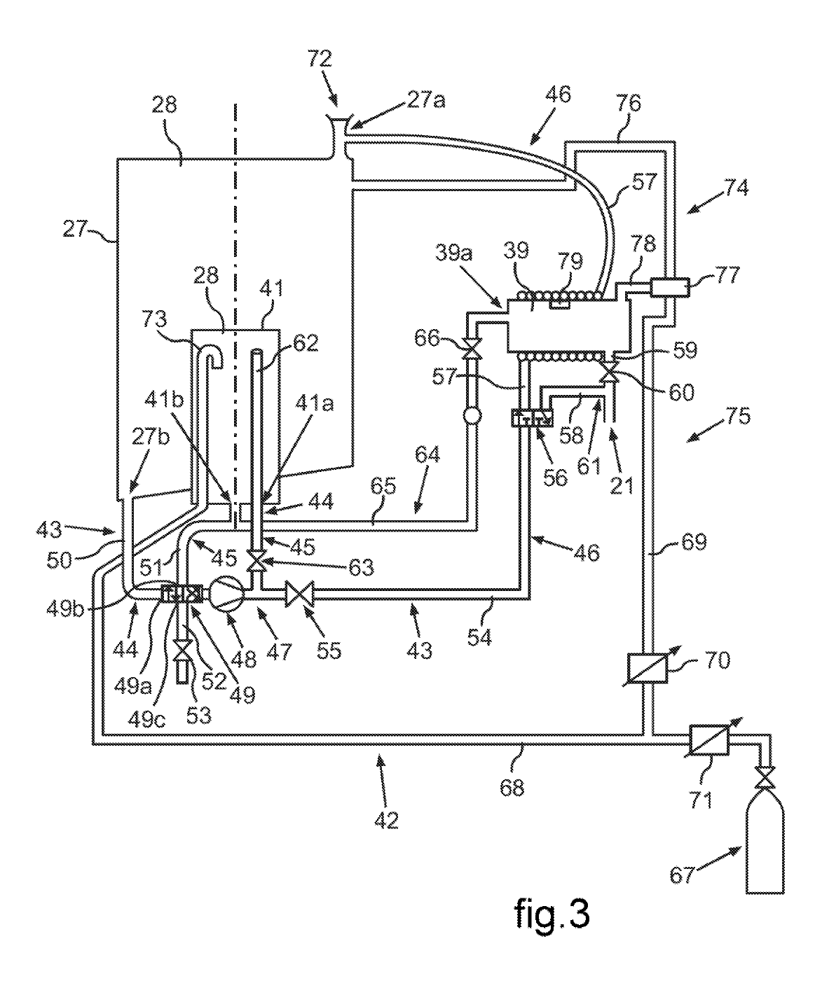

In FIG. 3, the drink producing apparatus 7 with partial components is shown in a schematic representation. In this context, it is to be mentioned that for example that system part is illustrated here, in which the first liquid 28 is stored and led. A corresponding construction, as it is shown in FIG. 3 and explained below, is then also present for the second liquid 30 in the drink producing apparatus 7 in corresponding manner. An explanation thereto is not explicitly performed and the facts set forth to FIG. 3 for one system part then also apply to this further system part, in which the second liquid 30 is stored and led.

In FIG. 3, the dispensing container 27 is shown, in which the first liquid 28 is contained in a first liquid state. This first liquid state is a non-carbonized state.

Moreover, a conditioning container 41 is shown in FIG. 3, which is separated from the dispensing container 27. This first liquid 28 is conditioned and provided in a second liquid state in this conditioning container 41, respectively. This second liquid state is a carbonized state.

The system shown in FIG. 3 moreover shows a line device 42 generally provided with the reference character, which represents a line network, by which the different components in the form of the dispensing container 27, the conditioning container 41 and the decompression chamber 39 are connected in fluid leading manner. In particular, the dispensing unit 20 with the dispensing opening 21 is also coupled to this line device 42 such that corresponding fluid leading connections to the dispensing container 27, the conditioning container 41 and the decompression chamber 39 exist here too.

The line device 42 comprises a first line connection 43, which is connected to the dispensing container 27 and the dispensing unit 20. Thus, the liquid 28 can be also directly led from the dispensing container 27 to the dispensing opening 21 via this first line connection 43. Thereby, the first liquid 28 can be led directly to the dispensing opening 21 from the dispensing container 27 without detour via the conditioning container 41 and without detour via the decompression chamber 39.

Moreover, the line device 42 includes a second line connection 44. The second line connection 44 is connected to the dispensing container 27 and the conditioning container 41. Moreover, the line device 42 includes a recirculation line connection 45. This recirculation line connection 45 is connected to an input 41a of the conditioning container 41 and to an output 41b of the conditioning container 41. The carbonized liquid 28 located in the conditioning container 41 in the second liquid state is circulated via this recirculation line connection 45.

In the embodiment, it is provided that the line device 42 additionally comprises a further recirculation line connection 46. This further recirculation line connection 46 is connected to an input 27a of the dispensing container 27 and to an output 27b of the dispensing container 27. The first liquid 28 contained in the dispensing container 27 in the first liquid state can be circulated via this further recirculation line connection 46.

An embodiment can also be provided, in which this further recirculation line connection 46 is not present. Similarly, an embodiment can be provided, in which the recirculation line connection 45 is not present, but the recirculation line connection 46 is then present.

The line device 42 comprises a line section 47, which is a constituent of the first line connection 43 and a constituent of the second line connection 44 and a constituent of the recirculation line connection 45. In the shown embodiment, it is moreover provided that this line section 47 is also a constituent of the further recirculation line connection 46 at the same time. This means that this line section is a simultaneous constituent of four line connections separately connected to different components of the drink producing apparatus 7.

A feed pump 48 is arranged in this line section 47, wherein it is in particular provided that this feed pump 48 is the only pump of the line device 42. This feed pump 48 is preferably a high-pressure pump. In particular, this line section 47 also comprises a 4/2-way valve 49. As is apparent, a line part 50, which opens into the output 27b of the dispensing container 27, is connected to a first port 49a of this 4/2-way valve 49. This line part 50 is a constituent of the first line connection 43 and also represents a constituent of the further recirculation line connection 46 in the embodiment.

Moreover, the line device 42 comprises a line part 51, which is connected to the output 41b of the conditioning container 41 and to a second port 49b of the 4/2-way valve 49. This line part 51 is also a recirculation line part of the recirculation line connection 45.

Moreover, the line device 42 includes a further line part 52, which represents a drain line. This line part 52 opens into a third port 49c of the 4/2-way valve 49. As is moreover apparent, a stop valve 53 is disposed in this line part 52, by which the drain or discharge of liquid from the line device 42 can be unblocked or stopped.

In flow direction of the first liquid 28, a further line part 54 is disposed after the first line part 50 and after the line section 47, which is a constituent of the first line connection 43 and is also a constituent of the further recirculation line connection 46 at the same time in the embodiment. This line part opens into a further stop valve 55, which is connected to the line section 47 on the other hand. Moreover, it is provided that this line part 54 opens into a further valve 56, wherein this further valve 56 is in particular a 3/2-way valve. As is furthermore apparent, a further line part 57 is connected to this further valve 56 on the one hand, connected to the input 27a of the dispensing container 27 on the other hand. Moreover, this line part 57 is laid multiple times turning around the outer side of the decompression chamber 39 such that a corresponding thermal coupling between this line part 57 and the decompression chamber 39 is achieved. In particular, cooling of the liquid in the decompression chamber 39 is thereby achieved since the first liquid 28 is preferably cooled stored in the dispensing container 27.

This line part 57 is therefore a constituent of the further recirculation line connection 46.

Moreover, a line part 58 is provided, which also opens into the valve 56 and is connected to the dispensing opening 21 on the other hand. This line part 58 is preferably then also a constituent of the first line connection 43, via which the first liquid 28 can be led from the dispensing container 27 then directly to the dispensing opening 21.

As is moreover apparent, the decompression chamber 39 also opens into the dispensing opening 21 by a line part 59. Thereby, the medium dispensed from the decompression chamber 39, namely the carbonized liquid 28 then brought to a lower pressure level, can be led directly to the dispensing opening 21. Here, it is in particular provided that a further stop valve 60 is arranged on the line path between the decompression chamber 59 and the dispensing opening 21. This stop valve 60 is preferably arranged upstream of an opening 61 in flow direction, at which the line part 58 opens into the line opening into the dispensing opening 21.

Moreover, it is provided that the recirculation line connection 45 comprises a line part 62 as a recirculation line part, which joins to the line section 47 downstream of it in flow direction of the liquid 28. Here too, it is provided that a further stop valve 63 is arranged between the line section 47 and this line part 62.

A further line connection 64 is formed between the conditioning container 41 and the decompression chamber 39. Thereto, a line part 65 is provided here too, which extends between an output 41b of the conditioning container 41 and an input 39a of the decompression chamber 39. Here, it is in particular provided that a valve 66 is arranged in this line part 65, which is also preferably a stop valve.

As is moreover shown in an example, the drink producing apparatus 7 includes a CO₂ container 67, by which carbon dioxide addition can be effected via a further line 68 to the conditioning container 41. In the embodiment, it is moreover provided that a connection between the container 67 and the decompression chamber 39 is formed via a further line part 69. Corresponding pressure controllers 70 and 71 are present in the line parts.

In the embodiment shown here, it is provided that the first line connection 43 comprises the line part 50, the line section 47, the line part 54 and the line part 58.

The second line connection comprises the line part 50, the line section 47 and the line part 62 in the shown embodiment.

The recirculation line connection 45 comprises the line part 51, the line section 47 and the line part 62 in the shown embodiment.

The further recirculation line connection 46 comprises the line part 50, the line section 47, the line part 54 as well as the line part 57, which are then recirculation line parts, in the shown embodiment.

In this context, a plurality of further line parts are also present in the embodiment, which are not associated with only one single line connection, but which are constituent of at least two line connections of the line device 42. The stop valves 55 and 63 each comprise two ports, into which the line section 47 opens at the one hand, further line parts 54 and 62, respectively, open at the other hand.

In an advantageous implementation, it is provided that at least one recirculation line connection is thermally coupled to a non-recirculation line connection such that the temperature level of the recirculation line connection can be transferred to the non-recirculation line connection. In this context, the thermal coupling can be realized by a heat exchanger, for example a thermally leading adhesive tape, which is preferably formed as a metallic adhesive tape. The thermal coupling between a recirculation line connection and a non-recirculation line connection can also be realized in a common insulation, which means that these two line connections are then surrounded by a common insulation. Similarly, it is possible that the thermal coupling between a recirculation line connection and a non-recirculation line connection is formed by a pipe-in-pipe system.

For example, it can be provided that a thermal coupling is formed between the line part 65 and the line part 54. In addition or instead, a thermal coupling can also be provided between the line part 65 and the line part 57. Preferably, pressure regulation to 2 bar is possible in the line part 69 such that the liquid then present in the decompression chamber 39 is reduced to a corresponding pressure level. On the other hand, it can be provided that a pressure of about 4 bar is set by the pressure controller 71 such that the first liquid 28 in the conditioning container 41, in which the liquid 27 is conditioned with the carbon dioxide, is on a correspondingly high pressure level.

Moreover, the dispensing container 27 comprises a filling opening 72, via which the first liquid 28 can be introduced. In particular, a filter can also be additionally present there.

Moreover, it can be provided that a check valve is also arranged in a line part 73 opening into the conditioning container 41, which introduces the carbon dioxide from the container 67.

Moreover, the line part 62 can comprise a nozzle for atomizing the liquid 28 to be introduced.

As is moreover shown in FIG. 3, the drink producing apparatus 7 is formed with a closed line circuit 74, which represents a carbon dioxide line device 75. Carbon dioxide in the drink producing apparatus 7 is circulated in this closed line circuit 74 and not discharged into the environment.

The carbon dioxide line device 75 and thus also in particular the closed line circuit 74 comprise the carbon dioxide addition unit 67. Besides the already explained line connections 68 and 69, which are the line connections of the carbon dioxide line device 75, the carbon dioxide line device 75 also comprises a further line connection 76. This line connection 76 is connected to the dispensing container 27 for leading carbon dioxide on the one hand, to a valve 77, which is in particular a 3/2-way valve, on the other hand. This line connection 76 is connected to the line connection 69 via this valve 77 on the one hand. Thereby, carbon dioxide can be directly led from the carbon dioxide addition unit 67 to the dispensing container 27 via the line connections 69 and 76.

On the other hand, the line connection 76 is also connected to the decompression chamber 39 via this valve 77. Thus, it can also be allowed that carbon dioxide is led from the decompression chamber 39 into the dispensing container 27 via the line connection 78, the valve 77 and the line connection 76. Moreover, it is possible that carbon dioxide can be led from the carbon dioxide addition unit 67 directly into the decompression chamber 39 via the line connections 69 as well as the valve 77 and the line connection 78. As is apparent, each line connection of the carbon dioxide line device 75 opens into a further component of the drink producing apparatus 7, in particular respectively into a further component, in which liquid is contained, in particular a container.

Independently of the configuration of the carbon dioxide line device 75 preferably as a closed line circuit 74, the carbon dioxide line device 75 can comprise the line connection 76, which is connected to the decompression chamber 39 and the dispensing container 27 for leading carbon dioxide from the decompression chamber 39 to the dispensing container 27.

In a further advantageous configuration, in addition or instead, it can be provided that the carbon dioxide line device 75 comprises a line connection 69 and a line connection 78, which is connected to the decompression chamber 39 and the carbon dioxide addition unit 67 for leading carbon dioxide from the carbon dioxide addition unit 67 to the decompression chamber 39.

In a further advantageous implementation, in addition or instead, it can be provided that the carbon dioxide line device 75 comprises a line connection 69 and a line connection 76, which is connected to the dispensing container 27 and the carbon dioxide addition unit 67 for leading carbon dioxide from the carbon dioxide addition unit 67 to the dispensing container 27.

In advantageous implementation, the drink producing apparatus 7 comprises a filling level capturing unit 79, which is formed for capturing a filing level of the carbonized liquid present in the decompression chamber 39. The filling level capturing unit 79 can comprise one or more detection units, which can be disposed in the decompression chamber 39 and/or outside of the decompression chamber 39. The filling level capturing unit 39 can comprise at least one ultrasonic sensor and/or at least one optical sensor and/or at least one capacitive sensor and/or at least one gas sensor and/or at least one float switch and/or at least two electrodes.

For operating the drink producing apparatus 7 and thus for producing and dispensing a drink, in an advantageous implementation, the dispensing container 27 is first completely filled with the first liquid 28. For example, this can be effected via a canister, which is coupled to the dispensing container 27 via the filling opening 72. After completely filling the dispensing container 27, it is then closed at its filling opening 72 in gas-tight manner by a mechanical or electrical valve.

If a drink is then subsequently to be dispensed and it for example is to comprise the liquid 28 from the dispensing container 27 in the non-carbonized state, thus, it can be led to the dispensing unit 20 and in particular to the dispensing opening 21 via the already explained line paths and thus the line connections set forth. When this is effected, the filling level of the liquid 28 in the dispensing container 27 decreases. In order to avoid a negative pressure in the dispensing container 27, carbon dioxide is introduced into the dispensing container 27 at the same time with the dispensing of the liquid 28 from the dispensing container 27, namely there not directly into the still present liquid 27, but into the arising clearance or cavity. This arising cavity is therefore then filled with the carbon dioxide. Therein, this carbon dioxide can be supplied from the carbon dioxide addition unit 67 into the dispensing container 27 via the line connections 69 and 76. However, it can also be provided that carbon dioxide is led from the decompression chamber 39 into the dispensing container 27 via the line connections 78 and 76.

If a drink is to be dispensed, which comprises carbonized liquid, on the other hand, thus, the filling level in the dispensing container 27 then decreases here too, since this liquid 28 is then first led into the conditioning container 41, is carbonized there and is led into the decompression chamber 39 from there. In the decompression chamber 39, in which the carbonized liquid is then brought to a lower pressure level, this carbonized liquid is then led to the dispensing opening 21. Here, it is then in particular provided that in this procedure carbon dioxide is also again introduced into the dispensing container 27. This too is effected according to the above mentioned possibilities via the line connections 69 and 76 or here preferably via the line connections 78 and 76. For this pressure reduction of the pressure of the liquid in the decompression chamber 39, fresh air is not supplied into the decompression chamber 39, but carbon dioxide is also supplied, which is in particular supplied from the carbon dioxide addition unit 67 via the line connections 69 and 78.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 first evaporator
26 second evaporator
27 first dispensing container
28 first liquid
29 second dispensing container
30 second liquid
31 jet
32 place of meeting
33 jet
34 addition medium
35 capsule
36 vessel
37 border
38 control unit
39 decompression chamber
40 decompression chamber
41 conditioning container
41a input
41b output
42 line device
43 first line connection
44 second line connection
45 recirculation line connection
46 recirculation line connection
47 line section
48 feed pump
49 4/2-way valve
49a first port
49b second port
49c third port
50 line part
51 line part
52 line part
53 stop valve
54 line part
55 stop valve
56 valve
57 line part
58 line part
59 line part
60 stop valve
61 opening
62 line part
63 stop valve
64 line connection
65 line part
66 valve
67 carbon dioxide addition unit
68 line
69 line part
70 pressure controller
71 pressure controller
72 filling opening
73 line part
74 closed line circuit
75 carbon dioxide line device
76 line connection
77 valve
78 line connection
79 filling level capturing unit

1. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second, carbonized liquid state different from the first liquid state,
a decompression chamber for pressure reduction of the carbonized liquid from the conditioning container, wherein the decompression chamber is connected to the conditioning container by a line part of the line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device is a closed line circuit.

2. Drink producing apparatus according to claim 1, wherein the carbon dioxide line device comprises a line connection, which is connected to the decompression chamber and the dispensing container for leading carbon dioxide from the decompression chamber to the dispensing container.

3. Drink producing apparatus according to claim 1, wherein the carbon dioxide line device comprises a line connection, which is connected to the decompression chamber and the carbon dioxide addition unit for leading carbon dioxide from the carbon dioxide addition unit to the decompression chamber.

4. Drink producing apparatus according to claim 1, wherein the carbon dioxide line device comprises a line connection, which is connected to the dispensing container and the carbon dioxide addition unit for leading carbon dioxide from the carbon dioxide addition unit to the dispensing container.

5. Drink producing apparatus according to claim 1, comprising:
a filling level capturing unit for capturing a filling level in the decompression chamber.

6. Drink producing apparatus according to claim 5, wherein the filling level capturing unit comprises an ultrasonic sensor.

7. Drink producing apparatus according to claim 5, wherein the filling level capturing unit comprises an optical sensor.

8. Drink producing apparatus according to claim 5, wherein the filling level capturing unit comprises a capacitive sensor.

9. Drink producing apparatus according to claim 5, wherein the filling level capturing unit comprises a gas sensor.

10. Drink producing apparatus according to claim 5, wherein the filling level capturing unit comprises a float switch.

11. Drink producing apparatus according to claim 5, wherein the filling level capturing unit comprises two electrodes for liquid detection.

12. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second, carbonized liquid state different form the first liquid state,
a decompression chamber for pressure reduction of the carbonized liquid from the conditioning container, wherein the decompression chamber is connected to the conditioning container by a line part of the line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device comprises a line connection, which is connected to the decompression chamber and the dispensing container for leading carbon dioxide from the decompression chamber to the dispensing container.

13. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second, carbonized liquid state different from the first liquid state,
a decompression chamber for pressure reduction of the carbonized liquid from the conditioning container, wherein the decompression chamber is connected to the conditioning container by a line part of the line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device comprises a line connection, which is connected to the decompression chamber and the carbon dioxide addition unit for leading carbon dioxide from the carbon dioxide addition unit to the decompression chamber.

14. Drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second, carbonized liquid state different from the first liquid state,
a decompression chamber for pressure reduction of the carbonized liquid from the conditioning container, wherein the decompression chamber is connected to the conditioning container by a line part of the line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device comprises a line connection, which is connected to the dispensing container and the carbon dioxide addition unit for leading carbon dioxide from the carbon dioxide addition unit to the dispensing container.

15. Household refrigeration apparatus comprising a housing, in which a receiving space for food is formed, and comprising a drink producing apparatus comprising:
a dispensing unit for dispensing liquid from the drink producing apparatus,
a dispensing container, which is formed for receiving a liquid addable to a drink by the drink producing apparatus in a first liquid state,
a conditioning container, in which the liquid can be conditioned into a second, carbonized liquid state different from the first liquid state,
a decompression chamber for pressure reduction of the carbonized liquid from the conditioning container, wherein the decompression chamber is connected to the conditioning container by a line part of a line device,
a carbon dioxide addition unit for adding carbon dioxide to the liquid,
a carbon dioxide line device, which is connected to the carbon dioxide addition unit for leading carbon dioxide from the carbon dioxide addition unit, wherein
the carbon dioxide line device is a closed line circuit.

16. Method for operating a drink producing apparatus, in which the following steps are performed:
providing the drink producing apparatus with a dispensing unit for dispensing liquid from the drink producing apparatus,
providing the drink producing apparatus with a dispensing container,
adding liquid with a first liquid state into the dispensing container,
providing the drink producing apparatus with a conditioning container,
providing the drink producing apparatus with a carbon dioxide addition unit,
providing the drink producing apparatus with a carbon dioxide line device, which is connected to the carbon dioxide addition unit for leading carbon dioxide from the carbon dioxide addition unit, wherein
the carbon dioxide line device is provided as a closed line circuit, in which the carbon dioxide is led,
leading the liquid from the dispensing container into the conditioning container and conditioning the liquid in the conditioning container into a second, carbonized liquid state different from the first liquid state, by leading carbon dioxide from the carbon dioxide addition unit into the conditioning container via the closed line circuit,
providing the drink producing apparatus with a decompression chamber, wherein this decompression chamber is connected to the conditioning container by a line part of a line device of the drink producing apparatus,
leading the carbonized liquid from the conditioning container into the decompression chamber and reducing the pressure of the carbonized liquid in the decompression chamber compared to the pressure in the dispensing container by discharging carbon dioxide from the decompression chamber, wherein
this discharged carbon dioxide remains contained in the closed line circuit.

17. Method according to claim 16, wherein the carbon dioxide discharged from the decompression chamber is supplied to another liquid containing component of the drink producing apparatus by the closed line circuit.

18. Method according to claim 17, wherein this carbon dioxide is supplied to the dispensing container.

19. Method according to claim 16, wherein the reduction of the pressure of the carbonized liquid is performed before dispensing the liquid from the dispensing unit.

20. Method according to claim 16, wherein the dispensing container is completely filled with the liquid before dispensing a drink by the drink producing apparatus, and the dispensing container is closed after completely filling.

21. Method according to claim 20, wherein upon dispensing a drink, which comprises the liquid, this liquid is dispensed from the dispensing container and thereby the filling level in the dispensing container decreases, wherein with decreasing filling level in the dispensing container, carbon dioxide is supplied from the carbon dioxide addition unit into the dispensing container via the closed line circuit.

22. Method according to claim 21, wherein the supply of the carbon dioxide is performed such that a negative pressure in the dispensing container is prevented.

23. Method according to claim 16, wherein upon dispensing the carbonized liquid from the decompression chamber to the dispensing unit, the filling level of the liquid in the decompression chamber is determined and carbon dioxide is introduced from the carbon dioxide addition unit into the decompression chamber via the carbon dioxide line device depending on the filling level.

24. Method according to claim 23, wherein the introduction of the carbon dioxide into the decompression chamber is stopped upon reaching a threshold filling level.

25. Method for operating a drink producing apparatus, in which the following steps are performed:
providing the drink producing apparatus with a dispensing unit for dispensing liquid from the drink producing apparatus,
providing the drink producing apparatus with a dispensing container,
adding liquid with a first liquid state into the dispensing container,
providing the drink producing apparatus with a carbon dioxide addition unit,
providing the drink producing apparatus with a carbon dioxide line device, which is connected to the carbon dioxide addition unit for leading carbon dioxide from the carbon dioxide addition unit,
completely filling the dispensing container with the liquid before dispensing a drink from the drink producing apparatus and closing the dispensing container after completely filling,
leading the liquid from the dispensing container to the dispensing unit for dispensing a drink after closing the dispensing container,
reducing the filling level of the liquid in the dispensing container by dispensing the liquid, wherein with decreasing filling level in the dispensing container, carbon dioxide is supplied into the dispensing container via the carbon dioxide line device.

26. Method for operating a drink producing apparatus, in which the following steps are performed:
providing the drink producing apparatus with a dispensing unit for dispensing liquid from the drink producing apparatus,
providing the drink producing apparatus with a dispensing container,
adding liquid with a first liquid state into the dispensing container,
providing the drink producing apparatus with a conditioning container,
providing the drink producing apparatus with a carbon dioxide addition unit,
providing the drink producing apparatus with a carbon dioxide line device, which is connected to the carbon dioxide addition unit for leading carbon dioxide from the carbon dioxide addition unit, wherein
leading the liquid from the dispensing container into the conditioning container and conditioning the liquid in the conditioning container into a second, carbonized liquid state different from the first liquid state by supplying carbon dioxide from the carbon dioxide addition unit,
providing the drink producing apparatus with a decompression chamber, wherein this decompression chamber is connected to the conditioning container by a line part of a line device of the drink producing apparatus,
leading the carbonized liquid from the conditioning container into the decompression chamber and reducing the pressure of the carbonized liquid in the decompression chamber compared to the pressure in the dispensing container by discharging carbon dioxide from the decompression chamber, wherein
in dispensing the carbonized liquid from the decompression chamber to the dispensing unit, the filling level of the liquid in the decompression chamber is determined and carbon dioxide is introduced into the decompression chamber via the carbon dioxide line device depending on the filling level.
